(19) United States
(12) Patent Application Publication
(10) Pub. No.: US 2026/0183191 A1
(43) Pub. Date: Jul. 2, 2026

(54) PRESSURE APPLYING DEVICE

(71) Applicant: Klaus Grübl, Braunau am lnn (AT)

(72) Inventor: Klaus Grübl, Braunau am lnn (AT)

(21) Appl. No.: 19/130,060

(22) PCT Filed: Nov. 15, 2023
(86) PCT No.: PCT/EP2023/081875

§ 371 Date: May 14, 2025

(30) Foreign Application Priority Data
Nov. 15, 2022 (EP) 22207544.2

(51) Int. Cl. A61H 39/04; A61H 39/00

(52) U.S. Cl. CPC A61H 39/04; A61H 39/002; A61H 2201/10; A61H 2201/168; A61H 2201/169; A61H 2205/027

(57) ABSTRACT

The present invention relates to a device for use in improving health conditions in a subject, configured to be mounted on a subject's ear, comprising an upper shackle, a lower shackle having a rail along the longitudinal side of the lower shackle and a curved end, at least two pressure elements.

### FIELD OF THE INVENTION

The present invention relates to the field of improving health conditions in an individual by an acupressure device.

### BACKGROUND ART

Bioelectronic medicine progressively comes into focus as a non-pharmaceutical treatment option for various diseases. Specifically, electrical stimulation of the auricular vagus nerve is an emerging technology in the field of bioelectronic medicine with applications in therapy. A large number of physiological processes and bodily states are associated with information transfer between the brain and body. These include diseases mitigating effects and sustainable therapeutic applications ranging from chronic pain diseases, neurodegenerative and metabolic ailments to inflammatory and cardiovascular diseases.

Tinnitus is a phantom sound perception in the ears or head and can arise from many different medical disorders. The condition is very common with a prevalence of 10 to 15%. There is little evidence for effective tinnitus treatments until the recent years. WO2019158674 and WO2021250104 for the first time disclose a device with proved effect for successfully treating tinnitus in afflicted individuals. The devices have only one pressure element which exerts soft pressure at various points at the ear. The device is configured as a bracket with a silicone plug to be located at the region of the posterior auricular muscle. The device is specifically configured for the treatment of tinnitus.

US2013/0301845A1 discloses an ear plug system including an ear plug device and an electronic control unit. The earplug device may be configured to also contain acupuncture nodes intended to apply pressure. This device contains a programmable microchip that is positioned within the earplug and is customizable to deliver user-specific soothing sounds to induce and maintain quality sleep.

However, subjects afflicted by a tinnitus usually have further health impairments, e.g., stress, pain, or psychometric dysfunctions which lead to further impaired health conditions.

Therefore, there is still the need for a device for treating tinnitus and/or improving health conditions in an individual.

### SUMMARY OF INVENTION

It is the object of the present invention to provide a device for treating tinnitus and/or improve health conditions in a subject. The object is solved by the subject matter of the present invention.

According to the invention, there is provided a device 100 to be worn behind an individual subject's external ear which is configured to improve the subject's health condition.

One embodiment of the invention relates to a device 100 for improving health conditions configured to be mounted on a subject's ear, comprising an upper shackle 110, a lower shackle 120 having a rail 122 along the longitudinal side of the lower shackle 120 and a curved end, and at least two pressure elements 300.

The upper shackle 110 and the lower shackle 120 are connected by connections means 130, the upper shackle 110 and the lower shackle 120 can be moved relatively to each other. At least two pressure elements 300 are mounted in the trail.

The upper shackle 110 and the lower shackle 120 may comprise a soft coating.

In one embodiment, the element 300 comprises 3 to 10 burls.

In one embodiment of the invention, two, three, or four pressure elements 300 are mounted in the rail 122.

According to one embodiment of the invention at least one pressure element 300 is located on the lower shackle 120 and can be moved along the rail 122.

A further embodiment relates to the device 100, wherein one pressure element 310 is fix located on the lower shackle 120 next to the connection means 130.

One embodiment of the invention relates to the device 100 comprising electrostimulation means. The electrostimulation means may be comprised in the pressure element 300.

Upon wearing the device 100, the upper shackle 110 is located on the upper side of the ear, the lower shackle 120 is located behind the auricle, the curved ending of the lower shackle 120 extends to the tragus.

The device 100 is specifically configured to stimulate various acupressure points around the ear upon wearing. Consequently, health conditions in a subject are improved upon wearing the device 100 as described herein.

A further embodiment relates to the use of the device 100 as described herein for improving health conditions in a subject. The pressure elements 300 located on the lower shackle 120 of the device 100 change the position of the pinna and/or stimulates various auricular acupressure points.

The pressure elements 300 may comprise several burls. According to one embodiment. According to one embodiment, the pressure elements 300 comprise 2, 3, or more burls.

One embodiment of the invention relates to the use of the devise 100 for a non-invasive treatment of tinnitus.

A further embodiment relates to the use of the device 100 wherein the pressure elements 300 of the device 100 stimulate the vagus nerve leading to positively affection of multiple physiological functions of a subject.

One embodiment of the invention relates to the individual device 100 as described herein, wherein the upper shackle 110 of the device rest on the upper side of the ear on the auricle and the lower shackle 120 rest behind the auricle and extends to around the lower auricle to the tragus.

A further embodiment relates to the device as described herein, wherein the pressure elements 300 stimulate various acupressure points around the ear.

A further embodiment relates to the device 100 as described herein, wherein the curved portion of the lower shackle 120 extends to the tragus and stimulates acupressure points at the front side of the ear.

A further embodiment relates to the device 100 as described herein, wherein the pressure elements 300 exert stimuli to the auricular vagus nerve.

One embodiment of the invention relates to the use of the device 100 as described herein for improving health conditions in a subject.

A further embodiment relates to the use as described herein, wherein the pressure elements 300 of the device 100 change the position of the pinna and stimulate various auricular acupressure points.

A further embodiment relates to the device 100 as described herein, for use in the treatment of tinnitus and/or for improving health conditions.

A further embodiment relates to the use of the device 100 as described herein, wherein the stimulation of the auricular vagus nerve affects multiple physiological functions.

A further embodiment relates to the use of the device 100 as described herein, wherein the multiple physiological functions are selected from the group consisting of neurological disorder, psychometric functions, metabolic syndrome, cardiovascular disorders, and pain.

### BRIEF DESCRIPTION OF DRAWINGS

FIG. 1 depicts a device 100 comprising two pressure elements 310,320.

FIG. 2 depicts a device 100 comprising two pressure elements 310,320.

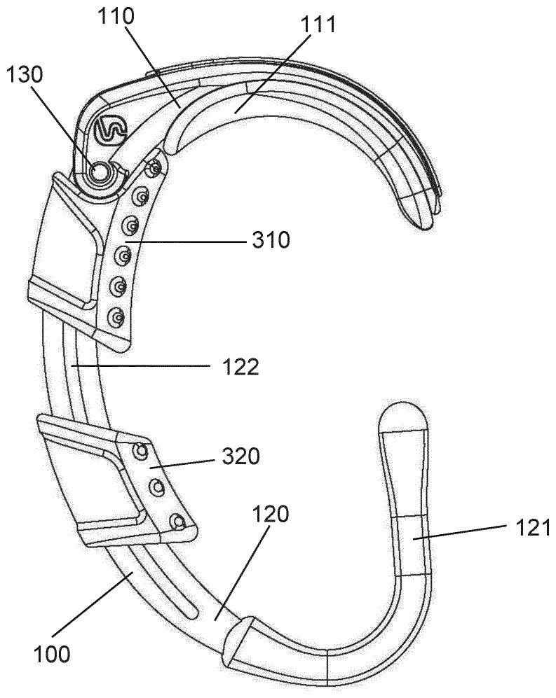

FIGS. 3A, 3B, 3C depict different shaped pressure elements 300.

### DESCRIPTION OF EMBODIMENTS

The present invention provides a device to be specifically configured to treat tinnitus and/or to improve health condition of an individual.

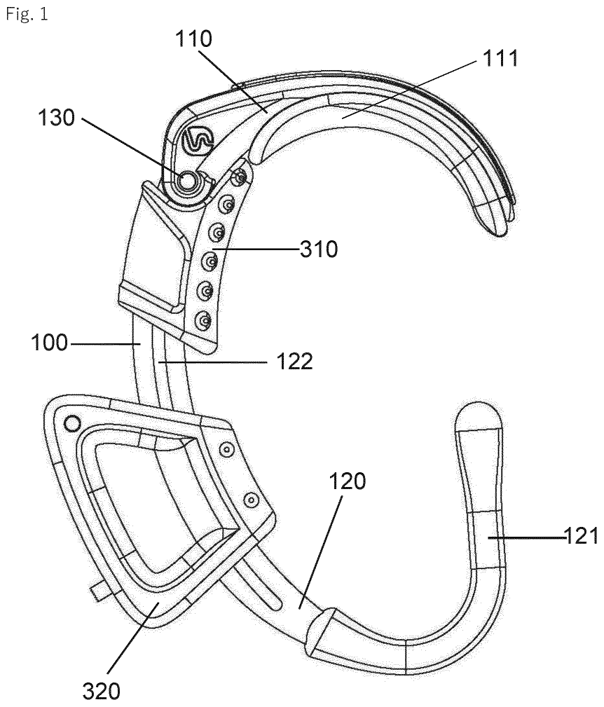

The device 100 comprises an upper shackle 110 which is connected via connecting means 130 to a lower shackle 120. The device is intended to be worn behind the outer ear (FIG. 1, 2).

The upper shackle 110 is slightly curved to fit on the upper side of a subject's ear. In order to avoid pressure marks, the upper shackle may comprise a soft coating. These coatings consist of a suitable material such as for example silicones, rubber, plastic, fabric, felt, foam, gel, rubber or similar materials. The coating may cover most of the upper shackle or may be shaped as an inlay.

The lower shackle 120 has slightly curved portion followed by a curved portion to surround the lower auricle and an approximately straight portion extending to the tragus. The slightly curved portion of the lower shackle exhibits a rail for mounting the pressure elements 300. The rail may be configured as an opening, notch, slot, gap, or the like. The pressure elements 300 are secured in this rail. The position of the pressure elements 300 can then be moved variably along the rail, so that the pressure elements 300 can be adapted individually to the needs of the subject (FIG. 1, 2).

The pressure elements 300 are mounted in the rail with suitable means. The securing means still allow moving the pressure elements 300 along the rail in order to allow the customer individual adjustments. For example, swivel joints may be used to enable travers of the pressure elements 300 along the linear guidance system. Alternatively, the pressure elements 300 may be secured in the slot, for example, by means of a clamping connection.

The upper shackle 110 and the lower shackle 120 may be connected by connection means 130, e.g., by a hinge, or a swivel joint.

The upper and the lower shackle may be made of stable materials. Particularly suitable are, for example, stainless steel, titanium, spring steel, other metals and metallic alloys, plastics, and the like.

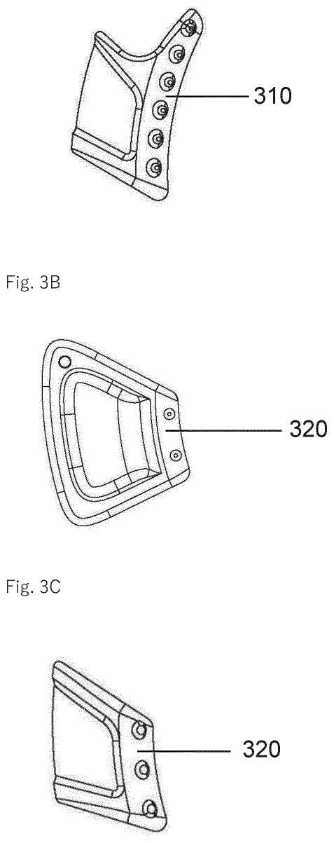

The pressure elements 300 may exhibit different shapes and sizes (see FIG. 3). The pressure elements 300 may comprise 2, 3, 4, 5, 6, 7, 8, or 9 burls. The burls additionally exert pressure to the to the auricular vagus nerve. The burls may be produced of soft tissue, e.g., silicones, rubber, plastic, fabric, felt, foam, gel, rubber or similar materials.

The pressure elements 300 can be produced from different materials. In principle, any material can be used which is suitable to form a corresponding shaped body and is comfortable to wear. For example, the pressure elements can be made of plastic, fabric, felt, foam, gel, rubber, elastic adhesive strips or similar materials. The pressure point body can be made of a foamed material, an elastic deformable material, or a plastic material, for example polypropylene.

The external ear, the pinna is the visible part of the ear and also known as the auricle. The function of the external ear is to collect sound by acting as a funnel, amplifying the sound and directing it to the auditory canal. The entire outer ear is the pinna. It is divided into different parts. Each individual's pinna creates a distinctive imprint on the acoustic wave traveling into the auditory canal. The numerous elevations and depressions of the auricle form acoustic resonators, which are excited each time sound hits from a certain direction. This creates direction-dependent minima and maxima in the frequency spectrum of the ear signal, which are used by the ear to determine the directions of incidence such as top, bottom, front or rear (directional bands).

The middle ear includes the eardrum and the ossicles hammer, anvil and stirrup. The round window connects the scala tympani of the inner ear with the middle ear. The Eustachian tube, also called the ear trumpet, connects the middle ear and nasopharynx. A mechanical impedance conversion takes place in the middle ear, which enables an optimal transmission of the signal from the outer ear to the inner ear. Since the acoustic impedance of water is approximately 3000 times that of air, without the lever system formed by the ossicles, only a small part of the sound energy that reaches the eardrum would be passed on to the inner ear.

The inner ear is located in a small cavity system (bony labyrinth) within the petrous bone, a portion of the temporal bone. In said bony labyrinth the membranous labyrinth is located, consisting of the cochlea, in which sound is converted into nerve impulses, and the organ of equilibrium. The organ of equilibrium consists of the semicircular ducts and two vesicular portions, the utriculus and the sacculus. The organ of equilibrium is used to detect changes in movement and the direction of gravity. The cochlea and the organ of equilibrium are of similar construction: both are filled with two common parallel fluid systems (perilymph and endolymph) and have hair cells. The hair cells are cylindrical and are named after the approximately 30 to 150 hair-like extensions at the upper end of the cell (stereocilia). The hairs are bent by movements of the fluid and thereby trigger nerve impulses. At the lower end there is a synapse with a sensory neuron. Said synapse releases neurotransmitters even in the resting state. If the hair extensions are deflected by sound vibrations or changes in the movement of the head, the amount of neurotransmitters changes. In the organ of equilibrium, the hair extensions are covered with a kind of gelatinous layer, on which small crystals of calcium carbonate are deposited, which intensify the effect of movements. From the cochlea, the auditory nerve together with the nerve bundles of the organ of equilibrium extend towards the brain as the vestibulocochlear nerve.

The effects of tinnitus strongly depend on the subjective perception and assessment of the ringing in the ears. Ringing in the ears can occur on one or both sides.

Tinnitus aurium means “ringing in the ears”. Medically, tinnitus is defined as an acoustic perception that arises from outside the body without a corresponding acoustic stimulus and has no information content.

A distinction is made in principle between two forms. In the case of objective tinnitus, there is a body's own sound source in the ear or near the ear, whose sound emissions are perceived. This means that the sounds that often emanate from the blood vessels or the muscles actually exist and can therefore also be heard by others, even if mostly only with a stethoscope or other medical devices.

Much more common, however, is subjective tinnitus. Here, those affected perceive sounds and noises that cannot be attributed to a physical sound source and therefore cannot be heard by other people. But this does not mean that the patients only imagine the humming, buzzing, whistling, ringing, rustling or knocking. Rather, subjective tinnitus is due to incorrect information formation or processing in the auditory system, which extends from the ear via the auditory nerve to the hearing centers in the brain.

For many of those affected, however, it is not possible to determine definitely the cause of the ringing in the ears. This is called idiopathic tinnitus.

Surprisingly, it has now been found that by changing the position of the outer ear relative to the rest of the ear, the sound is changed, that is to say, the sound is refracted compared to the “normal entry”. This leads to a different point of impact on the eardrum. As a result, the hammer (handle) of the first auditory bone is moved differently and sends changed pressure signals to the next auditory bones or then on to the cochlea. In the cochlea, the sensory hairs stored in a fluid are set in motion differently. This leads to a changed conversion of the electrical signals into the brain and to a change in the learning technology of the synapses—the previous sounds are no longer heard and thus “forgotten” in the long term.

There are many causes of tinnitus, from medications and pain relievers to neck or jaw issues, sleep deprivation and stress, anxiety, and depression. Studies have revealed that tinnitus may be associated with a synchronized hyperactivity in the auditory cortex. If someone has a lot of neck tension or jaw issues, these neurons run alongside the auditory nerve. When they are overactive or on fire, that energy bleeds over to the auditory nerve triggering those neurons to fire. Resulting in the perception of sound in the auditory cortex. Approximately two-thirds of people with tinnitus are able to alter the loudness and pitch of their tinnitus via somatic maneuvers, such as jaw clenching or tensing their neck muscles.

In addition to the change of the position of the outer ear relative to the rest of the ear, the device further addresses multiple acupressure points around the ear. The particularly device is configured to stimulate the muscles behind the ear such as the Musculus auricularis superior and the Musculus auricularis posterior.

The superior auricular muscle is a muscle above the auricle of the outer ear. It originates from the epicranial aponeurosis, and inserts into the upper part of the medial surface of the auricle. It draws the auricle upwards. The Musculus auricularis superior may be stimulated by the pressure elements of the device.

The posterior auricular muscle is a muscle behind the auricle of the outer ear. It arises from the mastoid part of the temporal bone, and inserts into the lower part of the cranial surface of the auricle of the outer ear. It draws the auricle backwards, usually a very slight effect. The Musculus auricularis posterior may be stimulated the pressure elements of the device which are positioned behind the auricle. The position of the pressure elements can be varied by the customer in order to address specific stimulation or acupressure points.

In addition, there is a complex bidirectional interaction between tinnitus and stress. Tinnitus patients often perceive their tinnitus as stressful, intrusive and annoying and a considerable subgroup develops insomnia, attentional and psychological problems such as anxiety or depression as a consequence of the ongoing tinnitus perception. A bidirectional interaction is suggested because stress can also aggravate tinnitus perception. Many patients report that the onset of their tinnitus was preceded by stressful events. The stress level and the affective state mediate the relationship between the loudness of the tinnitus and the individually perceived distress of tinnitus. Furthermore, dynamics of emotions are associated with the course of tinnitus over time, which adds to the complex interaction of tinnitus distress, tinnitus loudness, stress, and emotional perception. This complex interaction was also observed during the first wave of the COVID-19 pandemic.

The pressure elements of the device may be of different shape, size, and thickness, depending on the condition to be treated. The pressure elements of the device may be of individually customized size, shape, and thickness in order to specifically address the auricular vagus nerve. The external ear is an ideal place for a non-invasive stimulation of the vagus nerve. In fact, the auricular branch of the vagus nerve surfaces as the auricular afferent vagus nerve and thus forms a cutaneous receptive field in the pinna of the ear. This receptive field may be stimulated by the device according to the invention.

Due to changes in the entry angle of sound, the ear noises (tinnitus) perceived as “bothering” are no longer perceived, since the sound impinges on the eardrum at other points of impact.

Sound changes frequency due to a different refraction (change in path length). Frequency change due to change in distance between observer (eardrum) and sound source (Doppler effect). The sound path in the ear between the outer ear and the eardrum changes. For that reason, the previous “old” frequencies, which were perceived as bothering, are no longer perceived, since they changed in terms of “frequency” and are no longer perceived in the brain. This will mainly occur at high frequencies.

Using the device according to the invention, the entry angle of sound is changed so that those affected no longer hear the previously learned bothering sounds. The device according to the invention therefore comprises a pressure elements which are individually dimensioned to positioned behind the auricle. Thus, due to that pressure elements of the device, the position of the auricle is changed. By changing the position of the outer ear, the entry angle of the sound into the ear is changed.

In particular, it is advantageous to apply pressure to the external ear by the device. This pressure can result in that the position of the external ear is changed so that the entry angle of the sound is also changed and thus bothering tinnitus sounds are no longer heard. The perception of noises that are not caused by acoustic signals from the environment is reduced or eliminated altogether with the device according to the invention.

The number of pressure elements used on the device is dependent on the individual subject in need of such a device and of the intended function of the device. For the treatment of tinnitus, one pressure elements need to be located in the middle section of the device in order to exert a soft pressure on various stimulation points behind the ear and to change the position of the pinna. For improving other health conditions, the pressure element may be of a smaller size and thickness in order to exert only a soft pressure at the stimulation points behind the auricle without remarkably changing the position of the pinna.

One pressure element 310 is fixed on the upper side of the lower shackle close to the connection means in order to address the stimulation points over there.

Treatment of tinnitus or other health condition during sleep requires a customized device that can be easily worn during this time without interfering with sleep.

The ear is the closest organ to the brain and the most sensitive one due to its rapid transmission of stimuli. Treatment of various disorders via the ears has been known since centuries. For example, acupressure on certain points of the auricles can relieve headaches, toothaches, backaches, insomnia and other ailments.

Ear acupressure therapy has been used successfully in patients with insomnia (Cha N. H. et al., Holistic Nursing Practice 2017, 102-109). Patients suffering from tinnitus are often affected by insomnia as well. The curved portion of the individual device rests behind the ear and may stimulate respective points. Because of this stimulation, an improvement in sleep could be observed in the wearers of the device according to the invention.

Stress can be defined as any type of change that causes physical, emotional or psychological strain. Stress is your body's response to anything that requires attention or action. Everyone experiences stress to some degree. The way you respond to stress, however, make a big difference to your overall well-being. Stress affects both the brain and body. Little bit of stress is good for people to perform and protect themselves but too much stress can overwhelm them leading to fight, flight or freeze response. So learning how to cope with stress is important for our mental and physical wellbeing.

Stress is a feeling of emotional or physical tension. It can come from any event or thought that makes you feel frustrated, angry, or nervous. Stress affects the psyche in the same way as it affects the state of the body. It can lead to minor and serious illnesses, such as forgetfulness and concentration problems, sleep disorders, limited performance and creativity, nervous restless behavior, and much more.

The vegetative nervous system consists of two components which are active at the same time. One part, the so-called sympathetic nervous system, provides tension, the other part, the parasympathetic nervous system, provides relaxation. Stress leads to tension, and if tension persists, the vegetative nervous system tilts into a mode of overactivation of the sympathetic nervous system, while the parasympathetic nervous system is responsible for reducing stress in the human body.

The pressure elements of the device rest behind the ear and may stimulate respective points of the vegetative nervous system, more precisely the parasympathetic nervous system. Because of this stimulation, a reduction in stress could be observed in wearers of the device according to the invention.

Furthermore, studies have indicated a higher prevalence of sexual problems in patients with tinnitus, in particular an association between tinnitus and erectile dysfunction (ED) has been established. This connection was empirically examined in a Taiwanese study (Cheng Y-F. et al., Sci Rep. 2021, 11(1), 6982). Consequently, successful treatment of a tinnitus disorder may lead to positive impacts on an erectile dysfunction.

For improving other health conditions, the lower shackle of the device extends toward the tragus. This extension is intended to exert soft pressure on the tragus.

The vagus nerve is the 10th cranial nerve that starts at the brainstem with two bilateral branches and widely meanders and loops within the neck, thorax, and abdomen. The vagus nerve establishes a mutual connection between the brain and major body structures as pharynx, larynx, trachea, heart, aorta, lungs, and the entire gastrointestinal tract including esophagus, stomach, liver, pancreas, and spleen. The activity of the vagus nerve is proportionally associated with health, wellbeing, relaxation, and even emotions like empathy. The vagus nerve thus plays a crucial role in determining brain-body interactions (Kaniusas E., et al. Front. Neurosci 2019, 13, 1-23).

The external ear is the only place on the body where the vagus nerve sends its only peripheral branch. The auricular branch of vagus nerve surfaces as the afferent auricular vagus nerve and thus forms a cutaneous receptive field in the pinna of the ear. This field is susceptible to external stimuli in terms of peripheral nerve stimulation. In particular, auricular vagus nerve allows for an easy external access via electrical stimulation which then connects directly and favorably the applied stimuli to the brainstem (Kaniusas, 2019).

Thus, auricular vagus nerve stimulation is a peripheral, non-pharmacological and minimally invasive neuromodulation technique, altering signal processing in the central nervous system, activating reflex circuitries, exploiting brain plasticity for different therapeutic purposes, and thus, affecting profoundly different areas of the brain (Kaniusas, 2019).

Reported clinical application of the auricular vagus nerve stimulations in humans relate to neurological disorders, psychometric functions, metabolic syndrome, cardiovascular disorders, and pain. A positive influence of stimulation of auricular vagus nerve is also foreseen for epilepsy, depression, stroke, Alzheimer's disease, and many other disorders.

Up to date, the auricular vagus nerve is primarily electrically stimulated. Surprisingly, it was found that the device according to the invention also stimulates the auricular vagus nerve through the almost circular part of the approximately straight portion. Upon wearing the device, the pressure elements are located at the concha, thus stimulating the auricular vagus nerve.

The device according to the invention is specifically suited for the stimulation of the auricular vagus nerve. This is particularly advantageous because the individual subject must not waste time for attending respective premises where the bioelectronic medicine is applied via electrical stimulation. The device is intended for treating tinnitus and/or stimulating the auricular vagus nerve.

According to one embodiment of the invention, the device may optionally comprise electrostimulation means. A wide range of pulse patterns may be used in non-invasive nerve stimulation devices. The device comprising optionally an electrostimulation means provides relief through electrical stimulation of the auricular vagus nerve. Specifically, the device deliverers electro stimulation to the acupuncture point auricular vagus nerve of the individual. The electrostimulation means may be battery-powered device that operates by transcutaneous electrical stimulation of the auricular vagus nerve.

The electrostimulation means may be comprised in a housing in one of the pressure elements. Alternatively, the electrostimulation means may be mounted on the upper or lower shackle.

### EXAMPLES

The Examples which follow are set forth to aid in the understanding of the invention but are not intended to, and should not be construed to limit the scope of the invention in any way.

### Case Study

A longitudinal observation study is investigating the temporal development of tinnitus and related symptoms during a combination treatment. The combined treatment consists of the wearing the device around the ear(s) together with a smartphone app that provides self-help tips to the participants. The participants provide self-reports about tinnitus loudness, tinnitus stress, mood, stress level, tensions in the jaw and neck muscles as outlined in Table 1. In addition to these questions, participants answer if they were using the device and entered comments in a free text field.

TABLE 1
Questions for ecological momentary assessment

| No | Question | Answer Options |
|---|---|---|
| 1 | How loud do you currently | Visual slider on a scale from 0 (low) |
| | perceive the tinnitus? | to 10 (high) |
| 2 | How stressful is the tinnitus at | Visual slider on a scale from 0 (low) |
| | the moment? | to 10 (high) |
| 3 | What is your current mood? | 5 smileys from very sad (rating 1) to |
| | | very happy (rating 5) |
| 4 | How stressed do you feel right | Visual slider on a scale from 0 (no |
| | now? | stress) to 10 (maximum stress level) |
| 5 | How tense does your jaw feel | Visual slider on a scale from 0 (no |
| | right now? | tense at all) to 10 (very tensed) |
| 6 | How tense does your neck feel | Visual slider on a scale from 0 (no |
| | right now? | tense at all) to 10 (very tensed) |

The treatment and app assessment are done under naturalistic conditions and the data collection is reduced to a minimum to assess the development of tinnitus and other health conditions with high ecological validity and low intrusion to everyday life. Only the short questions within the app needs to be answered by the participants.

1. A device for improving health conditions configured to be mounted on a subject's ear, comprising:
a. an upper shackle,
b. a lower shackle having a rail along the longitudinal side of the lower shackle and a curved end, and
c. at least two pressure elements,
wherein the upper shackle and the lower shackle are connected so as to allow the upper shackle and the lower shackle to be moved relatively to each other, and
wherein the at least two pressure elements are mounted in the rail.

2. The device according to claim 1, wherein the upper shackle comprises a soft coating.

3. The device according to claim 1, wherein the curved ending of the lower shackle comprises a soft coating.

4. The device according to claim 1, wherein the pressure elements each comprises 3 to 10 burls.

5. The device according to claim 1, wherein two, three, or four pressure elements are mounted in the rail.

6. The device according to claim 1, wherein at least one pressure element is located on the lower shackle and can be moved along the rail.

7. The device according to claim 1, wherein one of the pressure elements is fixed on the lower shackle next to a connection means.

8. The device according to claim 1, wherein the at least two pressure elements differ in shapes and sizes.

9. The device according to claim 1, comprising electrostimulation means.

10. The device according to claim 9, wherein the electrostimulation means is comprised in at least one of the pressure elements.

11. The device according to claim 1, wherein upon being worn by the subject, the upper shackle is located on the upper side of the ear, the lower shackle is located behind the ear's auricle, and the curved ending of the lower shackle extends to the ear's tragus.

12. The device according to claim 1, wherein various acupressure points around the ear are stimulated upon wearing.

13. A method of improving a health conditions in a subject, comprising the step of placing the device of claim 1 on an ear of the subject.

14. The method of claim 13, wherein the pressure elements located on the lower shackle of the device change the position of the ear's pinna and/or stimulates various auricular acupressure points.

15. The method of claim 13, wherein the health condition is tinnitus.

16. The method of claim 13, wherein upon stimulation of a vagus nerve by the pressure elements, multiple physiological functions are improved.

17. The device of claim 1, wherein the upper shackle and the lower shackle are connected by a hinge or a swivel joint.

18. The method of claim 13, wherein the device is placed on the ear of the subject so that the upper shackle is located on an upper side of the ear, the lower shackle is located behind the ear's auricle, and the curved ending of the lower shackle extends to the ear's tragus.
